(19) United States
(12) Patent Application Publication
(10) Pub. No.: US 2021/0147228 A1
(43) Pub. Date: May 20, 2021

(54) A PROCESS FOR PRODUCING HYDROGEN AND CARBON PRODUCTS

(71) Applicant: SHELL OIL COMPANY, HOUSTON, TX (US)

(72) Inventors: Jacobus Johannes Cornelis GEERLINGS, Amsterdam (NL); Carolus Matthias Anna Maria MESTERS, Houston, TX (US); Leonardo SPANU, Houston, TX (US)

(21) Appl. No.: 17/045,949

(22) PCT Filed: Apr. 4, 2019
(86) PCT No.: PCT/EP2019/058450

§ 371 Date: Oct. 7, 2020

Related U.S. Application Data
(60) Provisional application No. 62/654,604, filed on Apr. 9, 2018.

(51) Int. Cl. C01B 3/00; C01B 32/162; C01B 3/26

(52) U.S. Cl. CPC C01B 3/0026; C01B 2203/148; C01B 3/26; C01B 32/162

(57) ABSTRACT

A process comprising passing methane through a reaction zone comprising a molten salt/metal bed under reaction conditions to produce a gas stream comprising hydrogen and a solid carbon product wherein the reaction zone comprises a hydrogen acceptor.

### CROSS REFERENCE TO RELATED APPLICATION

This application claims priority to U.S. Provisional Application Ser. No. 62/654,604 filed 9 Apr. 2018, the entire disclosure of which is hereby incorporated by reference.

### FIELD OF THE INVENTION

The invention relates to a process for producing hydrogen and carbon products.

### BACKGROUND OF THE INVENTION

Several processes are known for producing hydrogen and carbon products. For example, steam methane reforming is a process that converts natural gas to hydrogen. The methane from the natural gas and water are converted to synthesis gas (a mixture of hydrogen and carbon monoxide) over a catalyst. The carbon monoxide is then converted to carbon dioxide by reaction with water co-producing hydrogen via the water-gas shift reaction. Steam methane reforming is a very energy intensive process and the hydrogen must be separated from the carbon monoxide and carbon dioxide. This separation is quite difficult. In addition, the carbon dioxide produced must be sequestered or otherwise handled to prevent emission to the environment of the carbon dioxide. Other processes for producing hydrogen from hydrocarbons include gasification of coal, coke, oil or natural gas, which also co-produce carbon dioxide.

It would be desirable to develop a process that produces hydrogen that can be used without having to carry out the difficult separation from carbon dioxide/carbon monoxide. In addition, it would be desirable to produce a valuable carbon product from methane in a process that does not co-produce carbon dioxide and does not require a difficult separation of hydrogen from methane. Further, removing hydrogen from the reaction zone overcomes the reaction equilibrium limitations and provides for increased production of hydrogen.

### SUMMARY OF THE INVENTION

The invention provides a process comprising passing methane through a reaction zone comprising a molten salt/metal bed under reaction conditions to produce a gas stream comprising hydrogen and a solid carbon product wherein the reaction zone comprises a hydrogen acceptor.

The invention further provides a process for producing hydrogen and solid carbon comprising: a) contacting methane with a catalyst selected from the group consisting of iron, nickel, cobalt or mixtures thereof in a first reaction zone wherein the temperature is in a range of from 700 to 1200° C. to produce a first gas stream comprising hydrogen and unreacted methane and a first solid carbon product comprising carbon nanotubes; b) separating at least a portion of the carbon nanotubes from the first gas stream in a gas/solid separation apparatus; and c) passing at least a portion of the unreacted methane through a second reaction zone comprising a molten salt/metal bed wherein the molten salt/metal bed comprises a metal selected from the group consisting of iron, cobalt, nickel, tin, bismuth, indium, gallium, copper, lead, molybdenum, tungsten or a salt selected from the group consisting of lithium chloride, sodium chloride, potassium chloride, cesium chloride, magnesium chloride, calcium chloride, strontium chloride, barium chloride or mixtures thereof and a hydrogen acceptor selected from the group consisting of transition metals and compounds thereof at a temperature in the range of from 600 to 1000° C. to produce a second gas stream comprising hydrogen and unreacted methane and a second solid carbon product.

### BRIEF DESCRIPTION OF DRAWINGS

FIG. 1 depicts an embodiment of the process.

### DETAILED DESCRIPTION OF THE INVENTION

The invention provides an improved process for producing hydrogen and solid carbon product(s) from a feed comprising methane. The reaction is conducted in a reaction zone comprising a molten salt/metal bed. In addition to the molten salt/metal, a hydrogen acceptor is present in the reaction zone.

A stream comprising methane is fed to the reaction zone where it is converted into a gas stream and a carbon product. By using a hydrogen acceptor, the hydrogen produced in the reaction can be effectively separated from the other products produced in the reaction zone.

The gas stream that is fed to the reaction zone comprises methane and hydrogen. In addition, the feed may comprise one or more inert gases, for example, nitrogen.

The reaction zone comprises a molten salt or molten metal or mixtures thereof. The molten metals preferably comprise iron, cobalt, nickel, tin, bismuth, indium, gallium, copper, lead, molybdenum, tungsten or mixtures thereof. The molten salts may be alkali halides or alkaline earth halides. The molten salts preferably comprise lithium chloride, sodium chloride, potassium chloride, cesium chloride, magnesium chloride, calcium chloride, strontium chloride, barium chloride or mixtures thereof. The molten salt/metal is present in the reaction zone at a temperature above its melting point.

Preferred molten salts/metals may have a high thermal conductivity, a high density compared to carbon, and long term chemical stability. The molten salt/metal is chemically stable and can be used at temperatures up to about 1000° C.

In one embodiment, a solid catalyst is dispersed in the molten phase. The feed may be added at the bottom of the bed and the reaction is carried out as the feed passes through the molten salt/metal bed.

In prior art processes, significant problems were seen due to the deposition of solid carbon layers on the reactor walls. The use of a molten salt/metal bed where the solid carbon is formed in the bed prevents this carbon deposition on the walls.

For those skilled in the art, it is evident that the methane conversion is limited to thermodynamic constraints depending on the temperature, pressure and feed composition. These thermodynamic constraints can be shifted in view of the removal of hydrogen by binding with a hydrogen acceptor.

One or more hydrogen acceptors are present in the reaction zone. The hydrogen produced in the reaction zone is at least partially bound to the hydrogen acceptor. The binding of the hydrogen to the hydrogen acceptor and removal of the hydrogen from the molten salt/metal bed allows for overcoming the thermodynamic equilibrium limitations and for shifting the reaction equilibrium to the right.

The hydrogen acceptor used in this reaction can be any metal-containing alloy or a compound that has the ability, when subjected to these operating conditions, to selectively accept or react with hydrogen to form a sufficiently strong hydrogen-acceptor bond. The hydrogen acceptor preferably reversibly binds the hydrogen in such a way that during operation in the reaction zone the hydrogen is strongly bound to the acceptor under the reaction conditions. In addition, the hydrogen acceptor is preferably able to release the hydrogen when transported to a regeneration section where it is subjected to regeneration conditions that favor release of the previously bound hydrogen and regeneration of the hydrogen acceptor.

Suitable hydrogen acceptors include: Ti, Zr, V, Nb, Hf, Co, Mg, La, Pd, Ni, Fe, Cu, Ag, Cr, Th as well as other transition metals, elements or compounds or mixtures thereof. The hydrogen acceptor may comprise metals that exhibit magnetic properties, such as for example Fe, Co or Ni or various ferro-, para- or diamagnetic alloys of these metals. One or more hydrogen acceptors that exhibit appropriate particle sizes and mass may be used in the reaction zone to achieve the desired degree of hydrogen separation and removal.

The reaction may be carried out in any suitable reactor vessel. The feed is injected into the reaction zone and bubbles up through the molten salt/metal bed. The methane is decomposed inside of the bubbles as they rise in the reactor. When the bubbles reach the surface, the hydrogen, carbon and any unreacted methane is released. The hydrogen and unreacted methane are removed as a gas stream and the solid carbon product remains at the surface. In addition, at least a portion of the hydrogen is bound to the hydrogen acceptors. In some embodiments, additional separation steps may be needed to separate the solid carbon product from the molten salt/metal bed.

Another important feature of the reactor is that it needs to be resistant to corrosion caused by the high temperature salt or metal. In one embodiment, the reactor may be a packed column.

The reaction is carried out at a temperature in the range of from 600 to 1000° C., preferably from 700 to 800° C.

The catalyst and process conditions are preferably selected to provide a conversion of methane in the range of from 50 wt % to the thermodynamic limitation, preferably of from 75 wt % to the thermodynamic limitation. The methane conversion may be from 50 wt % to 100 wt %, preferably from 75 wt % to 100 wt %.

The reaction zone produces a solid carbon product and a gas stream comprising hydrogen. The gas stream may comprise at least 50 vol % hydrogen, preferably at least 75 vol % hydrogen and more preferably at least 90 vol % hydrogen. In addition, the hydrogen acceptor, when regenerated, will produce an additional gas stream comprising hydrogen.

In this reaction zone, carbon dioxide is not formed, so there is no need to separate carbon dioxide from the hydrogen before it can be used in other reactions. In addition to hydrogen in the gas stream, any unreacted methane will not negatively impact most downstream processes, including ammonia synthesis. This provides an advantage over other hydrogen production processes, for example, steam methane reforming which does produce carbon dioxide.

For example, in the production of ammonia, carbon dioxide is a catalyst poison, and thus a hydrogen stream that is free of carbon dioxide is especially beneficial for use in the production of ammonia. The carbon monoxide and/or carbon dioxide from a steam methane reforming process may need to be hydrogenated to methane to avoid poisoning, for example, ammonia synthesis catalyst which would require an additional reaction step that is not needed in this process.

The solid carbon product has a lower density than the molten salt/metal, so the solid carbon product stays at the top of the molten salt/metal bed which makes separation easier. The solid carbon product can be used as a raw material to produce color pigments, fibers, foil, cables, activated carbon or tires. In addition, the solid carbon product may be mixed with other materials to modify the mechanical, thermal, and/or electric properties of those materials. The final carbon morphology of the solid carbon product is controlled by the selection of the salt/metal, optional solid catalyst and reaction conditions.

The hydrogen acceptor may be separated from the molten salt/metal bed to so that it may be sent to a regeneration step. The hydrogen acceptor may be regenerated to remove the hydrogen. After regeneration, the hydrogen acceptor may be recycled to the molten salt/metal bed.

In addition to the hydrogen, the gas stream may additionally comprise unreacted methane. Due to the high conversion in this process step, the amount of unreacted methane is low, and if it is sufficiently low then a gas separation step to separate the methane from the hydrogen is not necessary. If a higher purity of hydrogen is required, pressure swing adsorption processes (PSA) can be used very efficiently because of the relatively low level of methane in the second gas stream.

In one embodiment, the inventive process can be used in conjunction with a process for producing carbon nanotubes. This embodiment can be used to produce hydrogen and two carbon products from natural gas using two separate process steps. The two different steps, catalysts, and process conditions will be further described hereinafter.

In the first process step, natural gas is fed to a first reaction zone where it is converted into a first gas stream and a first carbon product.

The feed to the first reaction zone comprises methane, and is preferably predominantly methane. In addition, the feed may comprise other low carbon number hydrocarbons, for example ethane. The feed may be a natural gas, refinery gas or other gas stream comprising methane. Natural gas is typically about 90+% methane, along with ethane, propane, higher hydrocarbons, and “inerts” like carbon dioxide or nitrogen. The feed may also comprise hydrogen produced in the second reaction zone that may be recycled to this reaction zone.

The feed is contacted with a catalyst in the reaction zone. The catalyst comprises a transition metal or a transition metal compound. For example, the catalyst may comprise iron, nickel, cobalt or mixtures thereof.

The catalyst may be a supported catalyst, and the transition metal may be supported on any suitable support. Suitable supports include Al₂O₃, MgO, SiO₂, TiO₂, and ZrO₂. The support may affect the carbon yields and the structure and morphology of the carbon products produced. In one embodiment, an iron catalyst that is supported on either alumina or magnesium oxide is used. The catalyst may be doped with molybdenum or a molybdenum containing compound.

In one embodiment, the catalyst is used in a fluidized bed reactor, so the catalyst has the proper characteristics to facilitate fluidization.

In another embodiment, the catalyst is generated in-situ in the first reaction zone via injection of a catalyst precursor to the first reaction zone. Suitable catalyst precursors include metal carbonyls and metallocenes.

The first reaction may be carried out in any suitable reactor, but the first reaction zone is preferably a gas/solid reactor. The reaction zone is operated at conditions that are suitable for producing a first carbon product. In one embodiment, using a supported catalyst, the gas-solid reactor is operated as a fluidized bed reactor with a temperature greater than 600° C., preferably from 700 to 1300° C. and more preferably from 700 to 1200° C. In another embodiment, a catalyst precursor is contacted with the feed in the first reaction zone at a temperature of 300 to 600° C. to form the solid catalyst that reacts with the feed at higher temperatures, up to 1300° C. in the remaining part of the first reaction zone.

In one embodiment, the reaction is carried out in the substantial absence of oxygen. The substantial absence of oxygen means that there is no detectable oxygen present in the reaction zone. In another embodiment, the concentration of oxygen is less than 100 ppmw, preferably less than 30 ppmw, and more preferably less than 10 ppmw.

In one embodiment, the reaction is carried out in the substantial absence of water. The substantial absence of water means that there is no detectable water present in the reaction zone. In another embodiment, the concentration of water is less than 100 ppmw, preferably less than 30 ppmw, and more preferably less than 10 ppmw.

The catalyst and process conditions are preferably selected to provide a conversion of methane in the range of from 3 to 75 wt %, preferably from 3 to 45 wt % most preferably 3-15 wt %. The selectivity to the desired carbon product is higher when this reaction is operated at a relatively low conversion.

The first reaction zone produces a first carbon product, that is preferably a solid carbon product. The carbon product preferably comprises carbon nanotubes. Carbon nanotubes are allotropes of carbon having a nanostructure where the length-to-diameter ratio is greater than 10,000; preferably greater than 100,000; and more preferably greater than 1,000,000. The diameter of a carbon nanotube is typically on the order of a few nanometers, while the length is on the order of a few millimeters. Carbon nanotubes are generally cylindrical in shape and have a fullerene cap. The nanotubes can have a single wall, double wall or multiple walls. Multiwalled nanotubes include multiple layers of graphene rolled in on themselves to form a tube shape. Single walled nanotubes are generally preferred for many applications because they have fewer defects, are stronger and more conductive than multiwalled nanotubes. Carbon nanotubes can be used in a variety of applications including nanoscale electronic devices, high strength materials, field emission devices and gas storage.

In addition to the carbon nanotubes, a first gas stream is produced that comprises hydrogen; any unreacted methane; hydrocarbon pyrolysis products from methane, for example, acetylene. The first gas stream may also comprise any higher hydrocarbons and inerts that were present in the feed to the first reaction zone.

The first carbon product and the first gas stream exit the reactor through one or more outlets, but in one embodiment, the products exit the top of the fluidized bed reactor through a common outlet. This combined product stream is passed to a gas/solid separator to separate the carbon product from the gas stream. The gas/solid separator may comprise one or more cyclones and/or one or more electrostatic precipitators. The carbon product is removed as a product and at least a portion of the first gas stream is passed to the second process zone. In other processes that may include a similar reaction for producing carbon nanotubes, the gas stream is typically burned as fuel due to the low value and difficulty in separating the hydrogen from the unreacted methane.

The second process step comprises a reaction in a second reaction zone comprising a molten salt/metal bed and a hydrogen acceptor as described earlier. At least a portion of the first gas stream is fed to a second reaction zone where it is converted into a second gas stream and a second carbon product. By feeding the gas stream from the first step, the gas stream can be effectively monetized at a value that is greater than that realized by typical carbon nanotube processes where the gas stream would have been burned as fuel.

The gas stream that is fed to the second reaction zone comprises methane and hydrogen. In addition to the first gas stream from the first reaction zone and separation step, additional methane and/or hydrogen may be added before it is fed to the second reaction zone. In addition, the feed may comprise one or more inert gases, for example, nitrogen.

The second reaction zone produces a second solid carbon product and a second gas stream comprising hydrogen. The second gas stream may comprise at least 50 vol % hydrogen, preferably at least 75 vol % hydrogen and more preferably at least 90 vol % hydrogen. In addition, hydrogen is produced when the hydrogen acceptor is regenerated.

By combining these two process steps, two different solid carbon products can be produced. In addition, a pure hydrogen stream can be produced that can be used in several different processes. The integration of these two process steps provides a hydrogen stream free from carbon monoxide/carbon dioxide impurities that does not require a separation from a methane stream. Further, a portion of the first carbon product formed is a highly valuable carbon nanotube product.

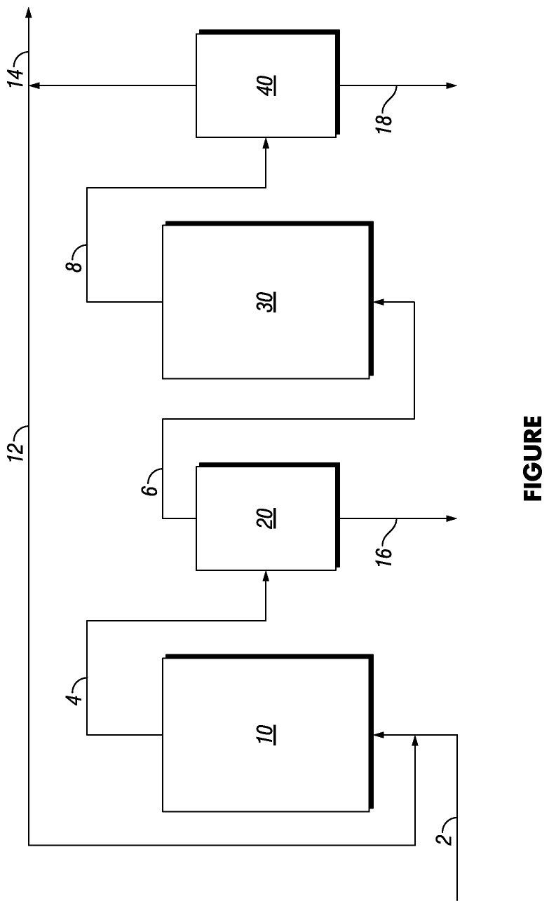

FIG. 1 depicts one embodiment of the process. In this embodiment, a feed comprising methane is passed via feed line 2 to a reactor 10. The reactor comprises a catalyst, and the methane is converted by methane pyrolysis into hydrogen and a solid carbon product. The reactor may be a fluidized bed reactor. The products are passed via line 4 to a separator 20 where the gaseous products are removed via line 6 and the solid products are removed via line 16. The gaseous product comprises a significant quantity of hydrogen and unreacted methane and the solid products are solid carbon products. Any entrained catalyst may be optionally separated from the carbon product and recycled to the reactor. The gaseous product is passed to a second reactor 30 where at least a portion of the unreacted methane is converted into additional hydrogen and additional solid products. This reactor comprises a molten salt/metal bed and a hydrogen acceptor. The products are removed via line 8 and then separated in separator 40. The gaseous product comprises hydrogen which may be removed as a product via line 14. Other gaseous products and optionally a portion of the hydrogen may be recycled to reactor 10 via line 12. The solid carbon products are removed via line 18. The hydrogen acceptor may be removed via line 18 or separated by another method not shown in the figure.

In a further embodiment, the above described processes may be integrated in a different order. In this embodiment, the methane is fed to a first reaction zone that comprises a molten salt/metal bed. The carbon product that is formed is separated from the product gas stream and the product gas stream is fed to a second reaction zone comprising a fluidized bed catalyst where a second carbon product is formed in addition to a second product gas stream.

1. A process comprising passing methane through a reaction zone comprising a molten salt/metal bed under reaction conditions to produce a gas stream comprising hydrogen and a solid carbon product wherein the reaction zone comprises a hydrogen acceptor.

2. The process of claim 1, wherein the molten salt/metal comprises iron, cobalt, nickel, tin, bismuth, indium, gallium, copper, lead, molybdenum, tungsten and mixtures thereof.

3. The process of claim 1, wherein the reaction conditions comprise a temperature in the range of from 600 to 1000° C.

4. The process of claim 1, wherein the carbon product has a density lower than the molten salt/metal.

5. The process of claim 1, wherein the hydrogen in the gas stream is at least partially bound by the hydrogen acceptor.

6. The process of claim 1, wherein the hydrogen acceptor comprises a metal or compound thereof that forms a hydride complex with hydrogen.

7. The process of claim 6, wherein the metal is a transition metal.

8. The process of claim 6, wherein the metal is titanium.

9. The process of claim 6, wherein the metal is zirconium.

10. The process of claim 1, further comprising removing at least a portion of the hydrogen acceptor from the reaction zone to remove the hydrogen bound to the hydrogen acceptor.

11. A process for producing hydrogen and solid carbon comprising:
a. contacting methane with a catalyst selected from the group consisting of iron, nickel, cobalt or mixtures thereof in a first reaction zone wherein the temperature is in a range of from 700 to 1200° C. to produce a first gas stream comprising hydrogen and unreacted methane and a first solid carbon product comprising carbon nanotubes;
b. separating at least a portion of the carbon nanotubes from the first gas stream in a gas/solid separation apparatus; and
passing at least a portion of the unreacted methane through a second reaction zone comprising a molten salt/metal bed wherein the molten salt/metal bed comprises a metal selected from the group consisting of iron, cobalt, nickel, tin, bismuth, indium, gallium, copper, lead, molybdenum, tungsten or a salt selected from the group consisting of lithium chloride, sodium chloride, potassium chloride, cesium chloride, magnesium chloride, calcium chloride, strontium chloride, barium chloride or mixtures thereof and a hydrogen acceptor selected from the group consisting of transition metals and compounds thereof at a temperature in the range of from 600 to 1000° C. to produce a second gas stream comprising hydrogen and unreacted methane and a second solid carbon product.
